(19) United States
(12) Patent Application Publication
(10) Pub. No.: US 2003/0068137 A1
(43) Pub. Date: Apr. 10, 2003

(54) Ferrule for an array of optical fibers and connector structure including this ferrule

(76) Inventors: David Rolston, Pierrefonds (CA); Tomasz Maj, Montreal (CA); Simon Cowley, McKinney, TX (US); Paul Marino, Elizabethtown, PA (US)

Correspondence Address: PERMAN & GREEN, 425 POST ROAD, FAIRFIELD, CT, 06824, US

(21) Appl. No.: 10/155,695

(22) Filed: May 24, 2002

(30) Foreign Application Priority Data
May 24, 2001 (CA) 2,348,359

(51) Int. Cl. G02B 6/36; G02B 6/43

(52) U.S. Cl. 385/78; 385/89

(57) ABSTRACT

A ferrule for holding an array of optical fiber sections comprises a longitudinal cavity and an edge face. The longitudinal cavity receives the array of fiber sections with the end faces thereof arranged in a line and coplanar to each other. The edge face includes a first face portion perpendicular to the longitudinal axes of the fiber sections, and a second bevelled face portion adjacent to the first face portion. The end faces of the fiber sections emerge from the first face portion. The ferrule is used in a connector structure including a bar with a top surface on which optoelectronic devices are arranged in a line and bonding contacts are disposed. An alignment assembly between the ferrule and the bar aligns the end faces of the fiber sections with respective optoelectronic devices. The bevelled face portion provides for clearance to enable unobstructed passage of wire-bonds connected to the bonding contacts.

### BACKGROUND OF THE INVENTION

1. Field of the Invention

The present invention relates to a ferrule for holding an array of laterally adjacent and substantially parallel and coplanar optical fiber sections. The present invention also relates to a connector structure, using this ferrule, between an array of optical fibers and a set of optoelectronic devices.

2. Brief Description of the Prior Art

Silicon ferrules are currently used for optically coupling the end faces of an array of optical fibers with respective optoelectronic devices, for example the laser elements of a VCSEL (Vertical Cavity Surface Emitting Laser) chip.

The prior art arrangements present the drawback that expensive flat connections are required between the control circuitry and the bonding flat contacts of the VCSEL chip.

### SUMMARY OF THE INVENTION

More specifically, in accordance with the present invention, there is provided a ferrule for holding an array of laterally adjacent and substantially parallel and coplanar optical fiber sections each having a longitudinal axis and an end face. This ferrule comprises an inner, substantially flat longitudinal cavity and an edge face. The inner, substantially flat longitudinal cavity receives the array of optical fiber sections with the end faces of these optical fiber sections arranged substantially in a line and coplanar to each other. The edge face comprises a first face portion substantially perpendicular to the longitudinal axes of the optical fiber sections, and a second bevelled face portion adjacent to the first face portion. The end faces of the optical fiber sections emerge from the first face portion and are substantially coplanar with this first face portion. In operation, the second bevelled face portion provides for clearance to enable unobstructed passage of wire-bonds in the region of the edge face of the ferrule.

Accordingly, the ferrule of the invention enables the use of low cost wire-bonds.

In accordance with a preferred embodiment, the first face portion and the second bevelled face portion intersect along a line substantially parallel to the line in which the end faces of the optical fiber sections are arranged. Advantageously, the line along which the fist face portion and the second bevelled face portion intersect Is adjacent to the end faces of the optical fiber sections. The end faces of the optical fiber sections define respective fiber edges which are preferably spaced apart from the line along which the first face portion and the second bevelled face portion intersect by a distance equal to or smaller than 30 microns.

In accordance with another preferred embodiment of the ferrule, the first face portion and the second bevelled face portion are planar surfaces defining between them an angle having a value located between 30° and 60°.

According to a further preferred embodiment:

the ferrule comprises two generally flat body portions defining between them the inner, substantially flat longitudinal cavity;

the inner, substantially flat longitudinal cavity comprises longitudinal grooves for individually positioning the optical fiber sections; and

the two body portions are made of silicon and are assembled together through epoxy glue.

According to a still further preferred embodiment, the ferrule comprises two holes situated on opposite sides of the array of optical fiber sections and coplanar with that array. These two holes advantageously open in both the first and second face portions of the edge face of the ferrule to receive respective ferrule alignment pins.

Also in accordance with the present invention, there is provided a connector structure between an array of optical fibers and a set of optoelectronic devices. This connector structure comprises a bar having a top surface on which the optoelectronic devices of the set are arranged substantially in a line and coplanar to each other. This bar further comprises bonding contacts disposed on the top surface and electrically connected to the optoelectronic devices. The connector structure further comprises a ferrule for holding laterally adjacent and substantially parallel and coplanar end sections of the optical fibers of the array, wherein each optical fiber end section has a longitudinal axis and an end face. This ferrule includes an inner, substantially flat longitudinal cavity receiving the optical fiber end sections with the end faces of these optical fiber end sections arranged substantially in a line and coplanar to each other. The ferrule also has an edge face comprising a first face portion substantially perpendicular to the longitudinal axes of the optical fiber end sections, and a second bevelled face portion adjacent to the first face portion. The end faces of the optical fiber end sections emerge from the first face portion and are substantially coplanar with this first face portion. The connector structure further comprises an optoelectronic device/end face alignment assembly between the ferrule and the bar and through which the end faces of the optical fiber end sections are aligned with respective light-emitting elements. Again, the second bevelled face portion provides for clearance to enable unobstructed passage, in the region of the edge face of the ferrule, of wire-bonds connected to the bonding contacts.

Therefore, the connector structure of the invention enables the use of low cost wire-bonds between a control circuitry and the bonding contacts on the top surface of the bar, these bonding contacts being electrically connected to the optoelectronic devices disposed on the top surface of the bar.

According to preferred embodiments:

the alignment assembly comprises, in the ferrule, first and second holes situated on opposite sides of the optical fiber end sections, substantially coplanar with these optical fiber end sections;

the first and second holes open in the edge face of the ferrule;

the alignment assembly comprises a ferrule holder, and this ferrule holder comprises a holder body with third and fourth holes at the opposite ends of the set of optoelectronic devices;

the first and third holes are generally coaxial, and the second and fourth holes are generally coaxial;

the alignment assembly comprises a first alignment pin inserted in the first and third holes, and a second alignment pin inserted in the second and fourth holes; and

the ferrule and the holder body are epoxy glued to each other.

The foregoing and other objects, advantages and features of the present invention will become more apparent upon reading of the following non restrictive description of a preferred embodiment thereof, given for the purpose of illustration only with reference to the accompanying drawings.

### BRIEF DESCRIPTION OF THE DRAWINGS

In the appended drawings:

FIG. 1 is a perspective view of a ferrule according to the present invention;

FIG. 2 is a side elevation view of the ferrule of FIG. 1, facing a bar with optoelectronic devices;

FIG. 3 is an enlarged, side elevation view of a portion of the ferrule of FIGS. 1 and 2 adjacent to the bar of optoelectronic devices;

FIG. 4 is a front elevation view a connector structure according to the invention, including an optoelectronic device/end face alignment assembly between the ferrule of FIGS. 1-3 and the bar of optoelectronic devices, through which the end faces of the optical fiber end sections are aligned with respective optoelectronic devices;

FIG. 5 is a side elevation view of the connector structure of FIG. 4; and

FIG. 6 is a perspective, enlarged view of a portion of the bar, showing one optoelectronic device, one bonding contact connected to the optoelectronic device, and a wire-bond bonded to the bonding contact.

### DETAILED DESCRIPTION OF THE PREFERRED EMBODIMENT

A preferred embodiment of the ferrule according to the present invention will now be described in connection with the appended drawings. In these appended drawings, the ferrule is generally identified by the reference 1.

The function of the ferrule 1 is to hold laterally adjacent and substantially parallel and coplanar end sections such as B of an array, for example a linear array 2 of optical fibers such as 3. Each optical fiber end section 8 has a longitudinal axis and an end face such cis 4.

The ferrule 1 presents the general configuration of a parallelepiped and comprises two generally flat body portions 5 and 8 defining between them an inner, substantially flat longitudinal cavity 7.

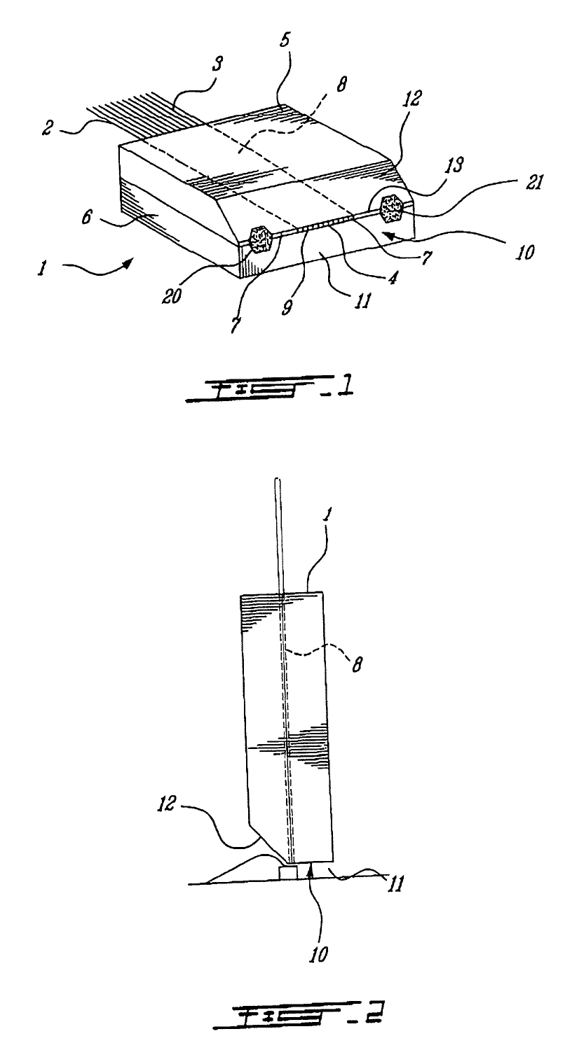

This inner, substantially flat longitudinal cavity 7 receives the array of optical fiber end sections 8. For that purpose, the inner, substantially flat longitudinal cavity 7 comprises longitudinal grooves such as θ on at least one of the confronting inner faces of the flat body portions 5 and 6 for individually positioning the optical fiber end sections laterally adjacent, substantially parallel and coplanar to each other. The grooves 9 are preferably V-shaped in cross section to properly position the optical fiber end sections 8. As better shown in FIGS. 1, 3 and 4, the end faces 4 of the optical fiber end sections 8 are arranged substantially in a line and coplanar to each other.

After the optical fiber sections 8 have been positioned in the respective grooves 9 of the longitudinal cavity 7, the two body portions 5 and 6 are adhered to each other. In the preferred embodiment, the two body portions 5 and 6 are made of silicon and are assembled together through epoxy glue. Of course other materials and fixation techniques could be contemplated.

The ferrule 1 as illustrated in FIGS. 1-5 comprises an edge face 10 including a first face portion 11 substantially perpendicular to the longitudinal axes of the optical fiber end sections 8, and a second bevelled face portion 12 adjacent to the first face portion 11.

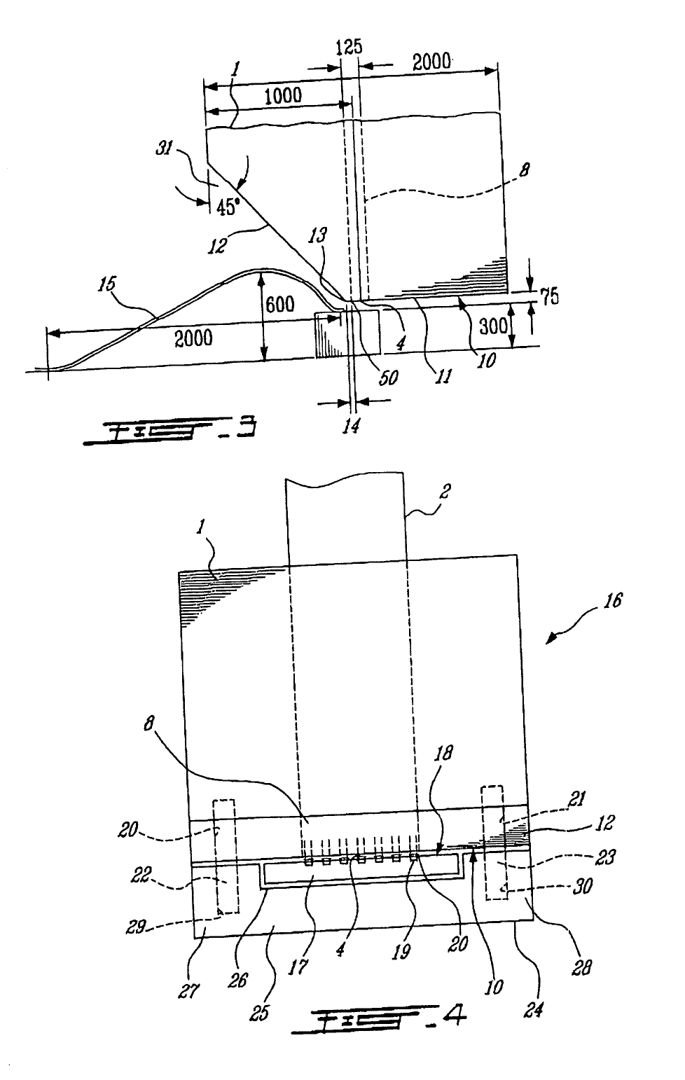

As shown in FIGS. 1 and 3, the end faces 4 of the optical fiber end sections 8 emerge from the first face portion 11. The end faces 4 are preferably polished simultaneously with face portion 11 whereby these end faces 4 are substantially coplanar both to each other and to this first face portion 11.

The first face portion 11 and the second bevelled face portion 12 intersect along a line 13 (FIGS. 1 and 3) substantially parallel to the line in which the end faces 4 of the optical fiber end sections 8 are arranged. Also, the line 13 along which the first face portion 11 and the second bevelled face portion 12 intersect is adjacent to the end faces of the optical fiber end sections 8. Ideally and more preferably, the fiber edges such as 50 at the respective end faces 4 of the optical fiber end sections 8 are spaced apart from the line 13 by a distance 14 (FIG. 3) equal to or smaller than 30 microns. However, strict adherence to this distance of 30 microns is not crucial.

As better shown in FIG. 3, the first face portion 11 and the second bevelled face portion 12 are planar surfaces defining between them an angle having a value preferably located between 30° and 60°. Again, strict adherence to this 30°-60° range is not crucial. The illustrated angle of 45° (see 31) between the face portions 11 and 12 is accordingly suitable. Of course, the second face portion 12 can be polished at the desired angle.

Still referring to FIG. 3, the beveled face portion 12 provides for clearance to provide sufficient space for unobstructed passage of wire-bonds such as 15 in the region of the edge face 10 of the ferrule 1. As can be seen, the wire-bonds 15 are undisturbed both electrically and physically.

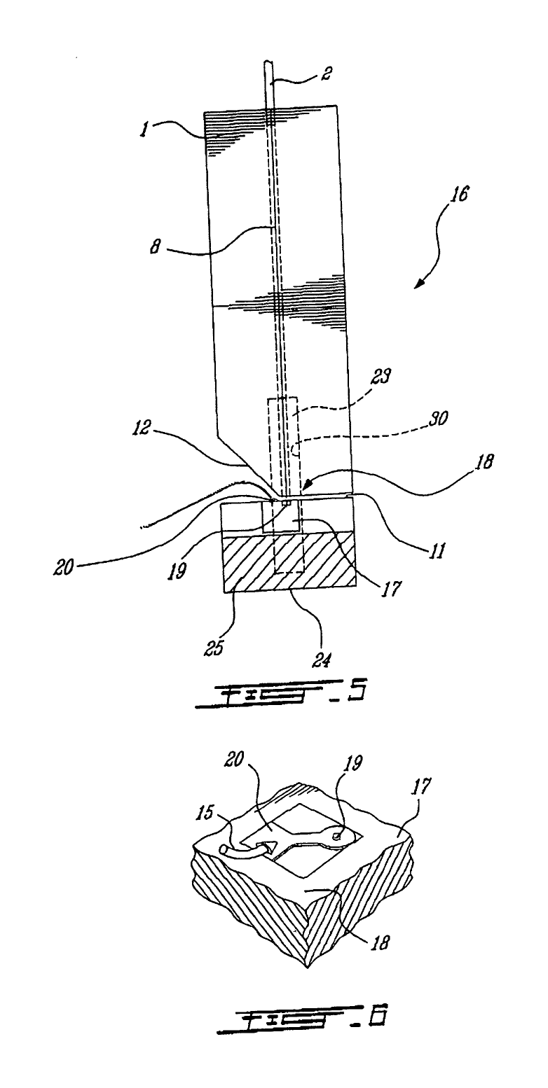

The ferrule 1 is used in a connector structure 16 (FIGS. 4 and 5) between the array 2 of optical fibers 3 and a set of optoelectronic devices such as light-emitting elements or optical detectors.

In the preferred embodiment illustrated in FIGS. 4, 5 and 6, the connector structure 16 comprises the ferrule 1 and a bar 17 having a top surface 18. The optoelectronic devices such as 19 of the set are arranged substantially in a line and coplanar to each other on top surface 18. Bonding contacts such as 20 are further disposed on top surface 18. There is a bonding contact 20 laterally adjacent to each optoelectronic device 19 and electrically connected to this optoelectronic device 19. In a particular application and as shown in FIG. 6, the bar 17 is a VCSEL (Vertical Cavity Surface Emitting Laser) chip, and the optoelectronic devices 19 are the VCSELs of this VCSEL chip. FIG. 6 shows one VCSEL 191 its corresponding bonding flat contact 20, and a wire-bond 15 bonded, for example ultrasonically bonded to this bonding contact 20.

An optoelectronic device/end face alignment assembly is interposed between the ferrule 1 and the bar 17. The function of this alignment assembly is to align the end faces 4 of the optical fiber end sections 8 with the respective optoelectronic devices 19.

This alignment assembly comprises the following elements:

A first 20 and second 21 holes are made in the ferrule 1 on opposite sides of the array of optical fiber end sections 8, substantially coplanar and parallel with this array of optical fiber end sections 8. These two holes 20 and 21 are hexagonal in cross section and open in both face portions 11 and 12 of the edge face 10 of the ferrule 1. Of course, the cross section of the holes 20 and 21 can present shapes other than hexagonal, for example cylindrical.

First 22 and second 23 ferrule alignment pins have respective first end sections press-fit in the respective holes 20 arid 21 of the ferrule 1. Of course, these alignment pins 22 and 23 may have a cross section which is hexagonal, cylindrical or presenting another suitable shape to fit in the holes 20 and 21.

A ferrule holder 24 comprises a holder body 25 U-shaped in front, elevation view as shown in FIG. 4. The U-shaped holder body 25 defines a cavity 26 in which the bar 17 is mounted, for example epoxy glued. The U-shaped holder body is further formed with opposite thicker end sections 27 and 28 having respective holes 29 and 30 situated at opposite ends of the set of optoelectronic devices 19.

In operation, hole 29 is generally coaxial with hole 20, and hole 30 is generally coaxial with hole 21. The alignment pin 22 has a second end section press-fit in hole 29. In the same manner, the alignment pin 23 has a second end section press fit In hole 30. Then, the end faces 4 of the optical fiber end sections 8 are accurately aligned with the corresponding optoelectronic devices 19 and, then, transparent light-propagating epoxy glue is added between the edge face 10 including the face portions 11 and 12, the top surface 18 of the bar 17, and the ferrule holder 24 to firmly hold the ferrule 1 in place. Other fixation techniques could of course be contemplated.

Referring to FIGS. 3 and 5, the second bevelled face portion 12 provides for clearance to enable unobstructed passage, in the region of the edge face 10 of the ferrule 1, of wire-bonds such as 5 connected to the contacts 20. For the purpose of illustration only FIG. 3 give plausible dimensions, in microns, for the ferrule 1 and connector structure 16.

Also, just a word to mention that, to reduce the complexity of the drawings, only a small number of optical fibers 3, optical fiber sections 8 and optoelectronic devices 19 have been illustrated in FIG. 4. In a practical embodiment, a larger number of optical fibers 3, optical fiber sections 8 and optoelectronic devices 19 will usually be provided.

Although the present invention has been described hereinabove by way of a preferred embodiment thereof, this embodiment can be modified at will, within the scope of the appended claims, without departing from the spirit and nature of the subject invention.

The embodiments of the invention in which an exclusive property or privilege is claimed are defined as follows:

1. A ferrule for holding an array of laterally adjacent and substantially parallel and coplanar optical fiber sections each having a longitudinal axis and an end face, comprising:
an inner, substantially flat longitudinal cavity receiving said array of optical fiber sections with the end faces of said optical fiber sections arranged substantially in a line and coplanar to each other; and
an edge face comprising a first face portion substantially perpendicular to the longitudinal axes of the optical fiber sections, and a second bevelled face portion adjacent to the first face portion, wherein:
the end faces of the optical fiber sections emerge from said first face portion and are substantially coplanar with said first face portion; and
the second bevelled face portion provides for clearance to enable unobstructed passage of wire-bonds in the region of the edge face of the ferrule.

2. A ferrule according to claim 1, wherein the first face portion and the second bevelled face portion Intersect along a line substantially parallel to the line In which the end faces of the optical fiber sections are arranged.

3. A ferrule according to claim 2, wherein the line along which the first face portion and the second bevelled face portion intersect is adjacent to the end faces of the optical fiber sections.

4. A ferrule according to claim 3, wherein the end faces of the optical fiber sections define respective fiber edges spaced apart from the line along which the first face portion and the second bevelled face portion intersect by a distance equal to or smaller than 30 microns.

5. A ferrule according to claim 1, wherein the first face portion and the second bevelled face portion are planar surfaces defining between them an angle having a value located between 30° and 60°.

6. A ferrule according to claim 1, comprising two generally flat body portions defining between them said inner, substantially flat longitudinal cavity.

7. A ferrule according to claim 6, wherein the two body portions are made of silicon and are assembled together through epoxy glue.

8. A ferrule according to claim 1, further comprising two holes situated on opposite sides of the array of optical fiber sections coplanar with said array of optical fiber sections, said two holes opening in both the first and second face portions of the edge face of the ferrule to receive respective ferrule alignment pins.

9. A ferrule according to claim 1, wherein the inner, substantially flat longitudinal cavity comprises longitudinal grooves for individually positioning the optical fiber sections.

10. A connector structure between an array of optical fibers and a set of optoelectronic devices, comprising:
a bar having a top surface on which the optoelectronic devices of said set are arranged substantially in a line and coplanar to each other, said bar further comprising bonding contacts disposed on said top surface and electrically connected to the optoelectronic devices;
a ferrule for holding laterally adjacent and substantially parallel and coplanar end sections of said optical fibers of the array, wherein each optical fiber end section has a longitudinal axis and an end face and said ferrule comprises:
an inner, substantially flat longitudinal cavity receiving said optical fiber end sections with the end faces of said optical fiber end sections arranged substantially in a line and coplanar to each other; and
an edge face comprising a first face portion substantially perpendicular to the longitudinal axes of the optical fiber end sections, and a second bevelled face portion adjacent to the first face portion;
wherein the end faces of the optical fiber end sections emerge from said first face portion and are substantially coplanar with said first face portion, and
an optoelectronic device/end face alignment assembly between the ferrule and the bar and through which said end faces of the optical fiber end sections are aligned with respective optoelectronic devices;
wherein the second bevelled face portion provides for clearance to enable unobstructed passage, in the region of the edge face of the ferrule, of wire-bonds connected to said contacts.

11. A connector structure according to claim 10, wherein the first face portion and the second bevelled face portion of the edge face of the ferrule intersect along a line substantially parallel to the line in which the end faces of the optical fiber end sections are arranged.

12. A connector structure according to claim 11 wherein the end faces of the optical fiber end sections define respective fiber edges spaced apart from the line along which the first face portion and the second bevelled face portion intersect by a distance equal to or smaller than 30 microns.

13. A connector structure according to claim 12, wherein the first face portion and the second bevelled face portion are planar surfaces defining between them an angle having a value located between 30° and 60°.

14. A connector structure according to claim 10, wherein the ferrule comprises two generally flat body portions defining between them said inner, substantially flat longitudinal cavity, said two body portions being made of silicon and being assembled together through epoxy glue.

15. A connector structure according to claim 10, wherein:
the alignment assembly comprises, in the ferrule, first and second holes situated on opposite sides of the optical fiber end sections, substantially coplanar with said optical fiber end sections;
said first and second holes open in the edge face of the ferrule;
the alignment assembly comprises a ferrule holder;
the ferrule holder comprises a holder body with third and fourth holes at the opposite ends of the set of light-emitting elements;
the first and third holes are generally coaxial;
the second and fourth holes are generally coaxial; and
the alignment assembly comprises a first alignment pin inserted in the first and third holes, and a second alignment pin inserted in the second and fourth holes.

16. A connector structure according to claim 15, in which the ferrule and the holder body are epoxy glued to each other.
